(19) United States
(12) Patent Application Publication
(10) Pub. No.: US 2026/0094065 A1
(43) Pub. Date: Apr. 2, 2026

(54) SELF-SUPERVISED LEARNING FOR TABULAR DATA MODELS

(71) Applicant: THE TORONTO-DOMINION BANK, TORONTO (CA)

(72) Inventors: Valentin Patrick Marie Thomas, TORONTO (CA); Junwei Ma, TORONTO (CA); Rasa Hosseinzadeh, TORONTO (CA); Hamidreza Kamkari, TORONTO (CA); Alexander Jacob Labach, TORONTO (CA); Keyvan Golestan Irani, TORONTO (CA); Maksims Volkovs, TORONTO (CA); Guangwei Yu, TORONTO (CA); Jesse Cole Cresswell, TORONTO (CA); Anthony Lawrence Caterini, TORONTO (CA)

(21) Appl. No.: 19/340,109

(22) Filed: Sep. 25, 2025

Related U.S. Application Data
(60) Provisional application No. 63/700,841, filed on Sep. 30, 2024.
(60) Provisional application No. 63/702,393, filed on Oct. 2, 2024.

(51) Int. Cl. G06N 20/00

(52) U.S. Cl. CPC G06N 20/00

(57) ABSTRACT

A foundational tabular data model is trained on a plurality of different data sets that may include non-simulated, real-world data. The tabular data model processes an input including a set of context data samples with corresponding labels and a query to be processed with the contexts and label as an example. The tabular data model may be applied to new data sets outside the training data using only the context of the new data set. To do so, the tabular data model is trained with training batches that include data samples from the plurality of data sets with different data fields (columns) selected as the target for tabular prediction of differing tasks and inputting data samples with inputs excluding the selected target, enabling the tabular data model to learn complex and varied relationships from real data without predefined labels or task objectives.

### CROSS-REFERENCE TO RELATED APPLICATIONS

This application claims the benefit of U.S. Provisional Application 63/700,841 filed on Sep. 30, 2024, and U.S. Provisional Application 63/702,393 filed on Oct. 2, 2024, the contents of each of which are hereby incorporated by reference in their entirety.

### BACKGROUND

This disclosure relates generally to tabular data models and more particularly to self-supervised learning for training tabular data models.

The challenges faced by neural networks on tabular data are well-documented and have hampered the progress of tabular foundation models. Such foundational models are trained on a variety of training data sets and intended to learn effective parameters for application to new data sets, particularly with the use of “in-context” data samples, enabling predictions for entirely new data sets without further training or hyperparameter tuning, therefore providing very fast inference when encountering a novel task. However, scaling in-context architectures for tabular data remains an issue: approaches based on large language models cannot efficiently process numeric tables, and tabular-specific techniques have not been able to effectively harness the power of real data to improve performance and generalization.

The high heterogeneity of tabular data sets, low availability of high-quality data, and the lack of obvious inductive bias have made it especially challenging to adapt neural architectures to tabular data. Particularly, few approaches effectively generate effective foundational models without extensive fine-tuning or hyperparameter tuning on new data sets for effective results.

In addition, while recent research has emphasized use of simulated data sets, these approaches may be insufficiently diverse and fail to account for relationships that exist in real data sets. Tabular data models using simulated data sets have also been trained exclusively for classification tasks, failing to provide effective solutions for regression analysis.

### SUMMARY

To improve tabular data models, a plurality of training data sets are used to automatically generate training data batches for tasks of a tabular data model. Particularly, the plurality of training data sets may include real-world data sets that lack labeled or otherwise specified targets for training the model. Rather, the training data for the model may be constructed to enable the tabular data model to learn cross-relationships between data fields by selecting different data fields as the target to be predicted by the model. As such, by using various different data sets and using different target data fields for prediction (and corresponding variation in other data fields to predict the target data fields), the tabular data model may learn a large variety of different predictive relationships between data fields. Particularly, despite the recent popularity of simulated data sets for foundational tabular data models, the use of real-world data sets enables the tabular data model to perform more effectively on benchmarks for new data sets than simulated data sets.

Training data for a training batch for the tabular data model may be generated by determining a training data input from each of the training data sets. Initially, each training data set may be preprocessed to normalize the training data fields and otherwise standardize the data for training. Each training data set may include a different set (and quantity) of data fields (e.g., “columns” in a table) and a different set of data samples (e.g., “rows”). In some embodiments, the tabular data model may be configured to generate outputs for a plurality of different tasks, such as classification and regression.

To generate a training data input, one data field is selected as a target for the task prediction and the remaining data fields may be used for determining input features for the model. A subset of data samples in the training data set are selected for the training data input and may include data samples that are in or “near” one another in the data set according to the data fields (excluding the selected target task). The data samples may then be assigned as context data samples or query data samples with respective input features. The input features may be determined based on the data fields after removing the selected target data field and may include further shuffling or removing data fields along with normalization to an input feature length for the tabular data model.

Across the various training data sets, different fields may thus be selected as the target and different types of data fields may be the remaining fields for generating the input features. In addition, selecting data samples for the training batches based on a distance metric excluding the target data field allows “nearby” context points to be selected that may be similar to how context data samples would be selected for inference of the target data field. Together, this approach enables effective variation of training target tasks, such that the tabular data model may be applied for inference of data samples of different data domains including those that have unique data fields relative to the training data sets.

### BRIEF DESCRIPTION OF THE DRAWINGS

FIG. 1 shows a tabular modeling system that includes a tabular data mode, according to one embodiment.

FIG. 2 shows an example of a tabular data model, according to one embodiment.

FIG. 3 is a flowchart of a method for evaluating queries for a tabular data model, according to one embodiment.

FIG. 4 shows an example data flow for generating a training batch for training the tabular data model, according to one embodiment.

FIG. 5 shows an example process for determining a training data input for a training data set, according to one embodiment.

FIG. 6 illustrates an example data flow for training a tabular data model, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Architecture Overview

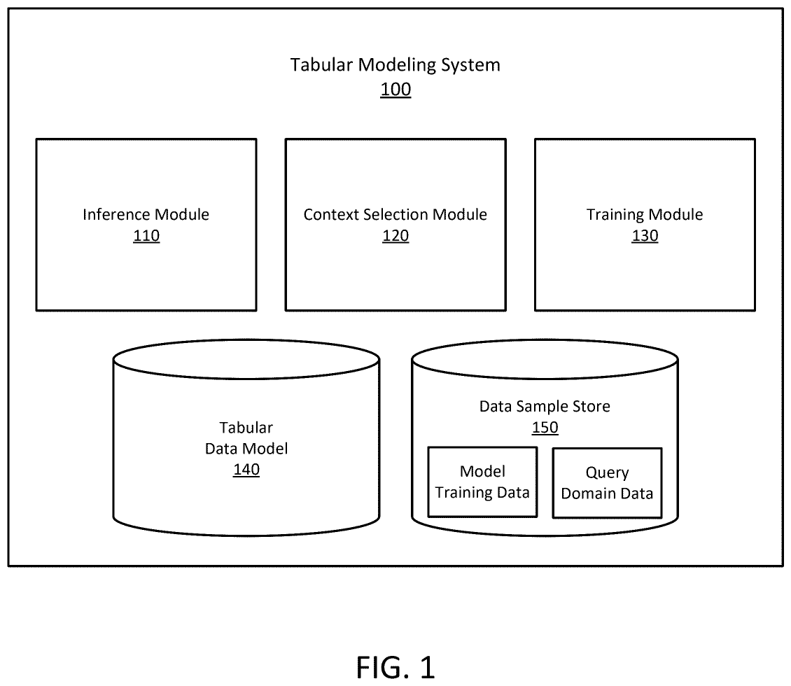

FIG. 1 shows a tabular modeling system 100 that includes a tabular data model 140, according to one embodiment. The tabular modeling system 100 includes various modules and data stores for training and using the tabular data model 140. In practice, additional or different modules and data stores may also be included in the tabular modeling system 100. In addition, the tabular modeling system 100 is shown here without connections to other systems; in practice, the tabular modeling system 100 may be connected to other systems and devices through a suitable network, such as the Internet, for receiving training data and applying the tabular data model 140 to new data items in inference.

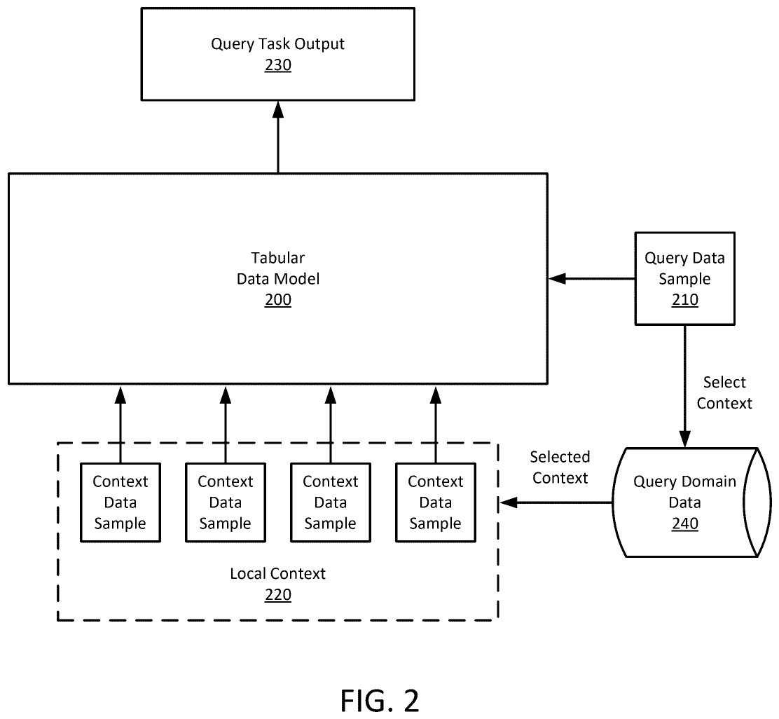

The tabular data model 140 is a trained computer model that learns parameters for interpreting tabular data and predicting data sample outputs for an input data sample. In various embodiments, the tabular data model 140 may be applied to generate outputs for a plurality of different tasks, which may include classification of the data sample or prediction of a discrete output value (e.g., a regression). The tabular data model 140 receives an input data sample along with a “context” that includes a plurality of context data samples as further discussed below and particularly in FIG. 2. As discussed further below, the tabular modeling system 100 may train the tabular data model 140 without requiring target task labels using a plurality of different types of training data sets that may include real-world tabular data.

For a tabular data sample (which may also be referred to as a “data point”), the information of a particular data sample may include a plurality of data fields that may be independent from one another, and may represent, for example, patient data for a hospital or financial data for an individual. That is, the independence of different tabular data features/characteristics (relative to one another) may differentiate this type of data from other types of data, such as image, sound, or video, where the data may be expected to contain higher degrees of correlation across portions of the input. For example, in contrast to tabular data, in image data, individual adjacent pixel data is often similar in value, and positioning may be analyzed to determine something meaningful about the image (e.g., edge detection based on nearby pixel differences). As such, in images and many other modalities, there may be underlying structural relationships between portions of the data that may not exist across tabular data fields.

In the examples herein, the tabular data model 140 may generate outputs for one or more tasks, such as classification or regression. The classification may describe, for example, membership in a particular group or a decision to be applied to a data sample. A regression task may be a discrete value (e.g., from a range) for the data sample. In additional examples, the output of the tabular data model 140 may be another type of task, such that different and/or additional types of data are generated by the tabular data model based on the input data sample and the context. As discussed below, a tabular data model may be trained to use a common backbone for multiple types of tasks.

The context selected for the tabular data model may provide relevant examples for the type of data being evaluated along with labels for the context data samples, such that the tabular data model 140 aims to determine an output corresponding to the appropriate label for the query data sample. In some embodiments, the tabular modeling system 100 determines a “local” context for use with a particular data sample. The local context enables more effective evaluation of data samples by selecting contextual data samples expected to be most relevant to evaluating the input data sample.

The tabular modeling system 100 may use data samples from a data sample store 150 for a context in training the model or when performing a query. The data sample store 150 may include a set of query domain data representing the set of data samples for particular domains that may be used to query the tabular data model 140. For example, queries may be performed for tabular data relating to medical data, such that individual data samples in the query domain data represent different individual patients and/or outcomes. When a request is received for evaluating a new data sample in that domain, the query domain data may be retrieved to obtain a context for applying the new data sample to the tabular data model 140. As discussed further below, in various embodiments, the tabular data model 140 may be pre-trained, such that the context is used to represent the specific data set relevant to the query (i.e., the query domain data) without training or fine-tuning of the tabular data model 140 to the individual domains.

FIG. 2 shows an example of a tabular data model 200, according to one embodiment.

A tabular data model 200 receives a query data sample 210 (e.g., data field values/features describing a data sample) along with a context 220 and processes the query data sample 210 and the context 220 according to parameters of the trained tabular data model 200 to generate a query task output 230. The tabular data model 200 may include a number of computer model processing layers (such as fully-connected layers, perceptrons, attention layers, activation layers, and so forth) with configurable parameters for processing the query data sample 210 and context 220 to yield the query task output 230. As discussed below, the tabular data model 200 includes parameters trained with a variety of data set types as model training data. As such, the trained parameters of the model have been trained on various data sets with a variety of data set distributions and types of tabular data and may include real-world and/or synthetic data sets representing different types of relationships that may appear in tabular data. Thus, in some embodiments, the tabular data model 200 is trained on a variety of different types of data distributions that may be expected to appear in tabular data, such that the tabular data model 200 may effectively use the input context points to represent various data domains that have not been included in the training data.

To apply the tabular data model 200 with a particular data set, the context 220 provides information about other points (i.e., the context points) within the particular data distribution in which the query data sample 210 appears. The trained tabular data model 200 may apply one or more attention layers to the context points and/or data sample, and in some embodiments may be a transformer-style computer model. In some embodiments, the trained tabular data model is a TabPFN (Tabular Prior-Data Fitted Network) architecture. In some embodiments, the parameters of the trained tabular data model 200 are pre-trained from the perspective of the tabular modeling system 100. As such, the trained tabular data model 200 may encode various types of prior distributions and related processing in the parameters of the trained tabular data model 200, such that the context 220 may be used to describe the particular distribution for evaluating the current query data sample 210.

In general, however, the number of context points are relatively few and may be 5, 10, 100, 500, or 1000 context points, and may be smaller than the total number of data samples available for the data set related to the context. In various types of tabular data models, the architecture (e.g., a transformer architecture and attention mechanisms) may scale model complexity and/or runtime quadratically. As such, modifying the length of the context (e.g., to account for additional context points) may significantly increase processing time or other costs of the tabular data model 200. As discussed further below, the context for a particular data set may be trained to enable refined evaluation of the data sample classification for that data set without requiring retraining (e.g., fine-tuning) of the trained tabular data model 200.

In some embodiments, rather than use the same context for many (or all) data samples, the query data sample 210 being evaluated is used to select a context 220 of context points that is “local” to the query data sample 210 in the query domain data 240. For example, the query domain data may have a number of data samples significantly larger than a context size, such that a subset of the query domain data 240 is selected as the context 220. A local context 220 may include, for example, 100 data samples selected from 1,000, 10,000, or more data samples in the query domain data 240.

Returning to FIG. 1, in operation, the tabular data model 140 processes a data sample and a context to generate a data sample classification. To perform inference on a new data item, an inference module 110 receives a new data sample and identifies the data set (i.e., the query domain data) associated with the new data sample. The associated query domain data is used to identify the context for the data sample by a context selection module 120 as further discussed below. The context, which may be optimized for that particular data sample and query domain, may then be provided as an input to the model along with the data sample to determine a task output for that data sample, as shown in FIG. 2. The inference module 110 may thus receive data samples from various sources (such as external devices), identify the local context relevant to the respective data samples with context selection module 120, and evaluate the data samples with the tabular data model 140 for one or more tasks based on the respective contexts. Additional information regarding the selection and use of local context for tabular data models is also discussed in U.S. patent application Ser. No. 19/209,875, filed May 16, 2025, and U.S. patent application Ser. No. 19/209,870, filed May 16, 2025, the contents of each of which are incorporated by reference in the entirety.

In some embodiments, the same tabular data model 140 can be applied to different data sets (e.g., different data distributions) by selecting an effective context, enabling re-use of the same tabular data model 140 and avoiding otherwise expensive memory operations of loading separate tabular data models 140 for different data sets. As the number of parameters in the tabular data model 140 may be very large (e.g., in the hundreds of thousands, millions, or billions), this may significantly improve the performance of the tabular modeling system 100, particularly when different data sets are used in practice. As such, the tabular data model 140 in some embodiments may be pre-trained (e.g., on training data from a variety of data distributions as discussed below) and may be used as-is by the tabular modeling system 100 with a context to apply the model to a new data set without additional fine-tuning to a queried data set.

The context selection module 120 may determine the local context for a data sample in various ways in different embodiments. In general, the context selection module 120 selects data samples from the relevant data set (e.g., the query domain data) that are expected to be most relevant to correctly evaluating a query data sample. These data samples may be selected as the points that are “closest” to the query data sample. In one embodiment, the selected data samples are the k nearest neighbors (kNN) of the query data sample. Distance between data samples (e.g., the query data sample and a data sample in the query domain data) may be measured with any suitable metric.

As one example, the distance between data samples may be measured in the domain of the tabular data. For example, tabular data may include various fields having values within various ranges, such as 0-1, 0-100, or another range, which may differ across different fields. As such, the values may be pre-processed or otherwise modified before being used to measure a distance metric between data samples. In one embodiment, the values for each field may be normalized to reflect the value of that field relative to a range of values for that field across the relevant domain, for example, to normalize the values to a range between zero and 1. In some embodiments, the normalization may scale values according to the range for the related field, and in other embodiments, the normalization may indicate the respective percentile value of the data sample in the field. As such, distances may be measured according to values of the data fields in the tabular data. Distances may be measured, for example, as a Euclidian distance between data samples according to differences between respective data fields for the tabular data samples.

In additional embodiments, embeddings or other low-level data representations may be used to represent the tabular data samples for distance measurements. For example, data samples in a domain may be used to train an encoder to an embedding representation of the tabular data samples. The encoder may be trained with unsupervised data (e.g., with a reproduction loss when processed by a decoder) to obtain parameters for encoding relevant information about the query domain data. In some embodiments, the embeddings of a data sample are used to determine a distance metric between data samples, for example, by measuring the distance as a cosine similarity between the embeddings of two data samples.

The context selection module 120 may select “local” data samples for a query request (e.g., for executing a query received by the inference module 110) or may select a “neighborhood” of data samples when used for training (i.e., typically by fine-tuning) by a training module 130. The context selection module 120 may select a number of data samples based on the distance to the subject data sample (e.g., a query data sample or a sampled training data sample) according to the distance metric and return the data samples to the requesting module (e.g., the inference module 110 or training module 130). The number of selected points may vary in different embodiments and in different circumstances and are discussed further below. The context selection module 120 typically selects a set of nearest neighbors to the subject data sample according to the distance metric, although other selection means may also be used in further embodiments.

In some circumstances, the tabular modeling system 100 includes a training module 130 that may train (e.g., fine-tune) parameters and other configuration settings of the tabular data model 140 as a foundational model (e.g., from a plurality of different data sets) or for a particular data domain. The data sample store 150 may include training data related to various data samples, which may be referred to as “data samples” or “instances,” to be used for determining parameters of the model. The data sample store 150 may include model training data for training model parameters of the tabular data model 140.

In some embodiments, the tabular data model 140 may be trained on various data sets suitable for transfer learning (with an appropriate context) to a variety of other data sets using the context. In these embodiments, the model training data may include data for a variety of domains, and may include data from a plurality of real-world data sets and may also include simulated or generated data, such that the various training data sets reflect different types of relationships between tabular data fields, and so forth. The tabular data model 140 may thus learn parameters configured for general relevant relationships among data instances for the various training data sets.

The model training data may be used to train parameters of the tabular data model 140. In some embodiments, the tabular data model 140 is trained by another system and is received by the tabular modeling system 100 as pre-trained. The model training data may include a number of different types of tabular data with different types of relationships between data samples, features, and classifications. As such, the model training data may include various distributions with different types of data set contexts. The tabular data model 140 may be trained for various types of data distributions based on the variety of data distributions in the model training data. The training data sets may include, for example, data sets relating to industrial/operational data, medical data, biology, physics, human behavioral data, and other types of training data sets that may include real-world data sets.

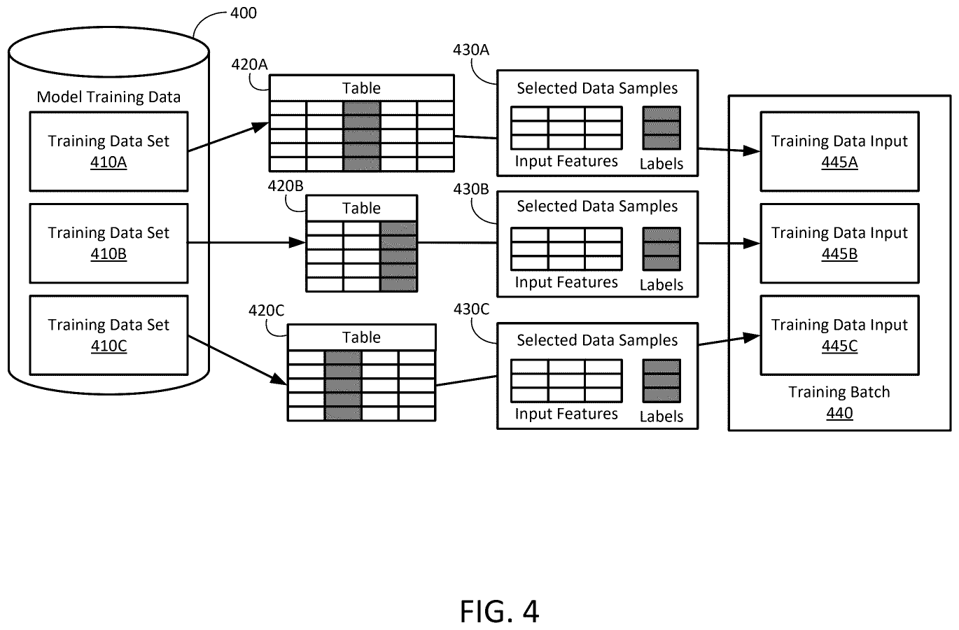

To effectively use these various data sets and learn interrelationships between data fields in these different domains, the training module 130 may construct training batches for the model that selects a data field from each training data set as a target data field and constructs a training data input for a task based on the target data field. The remaining data fields for the data set may then be used to generate input features for characterizing data samples, enabling the training module 130 to generate a wide variety of training batches for different potential tasks automatically. Additional details regarding the generation of a training batch and model training are discussed below, particularly with respect to FIG. 4 et seq.

The tabular modeling system 100 is shown in relation to the components particularly related to the improved operation and training of the tabular data model 140 as discussed herein. As such, the particular environment in which the tabular modeling system 100 operates may differ in various embodiments, as the tabular modeling system 100 may be operated on a server that receives requests from remote computing systems for application of requests to the tabular data model 140. In other embodiments, the tabular data model 140 may be trained by one computing system and deployed to another computing system for application (e.g., downloaded by a mobile device for operation of the tabular data model 140). In additional embodiments, the training of the tabular data model 140 may also be separated to different computing systems-training of the model parameters with the model training data may be performed by one system, and training of a context for a data set using the query domain data may be performed by another system. As such, the tabular modeling system 100 is any suitable computing system; components as disclosed below may be separated or combined appropriately across different computing systems for operation. For example, training of the tabular data model 140 may also be executed by a plurality of systems in parallel that may share information about modifying model parameters during training. Similarly, further components and features of systems that may include the tabular modeling system 100 itself and systems that may include components of the tabular modeling system 100 may vary and include more or fewer components than those explicitly discussed herein.

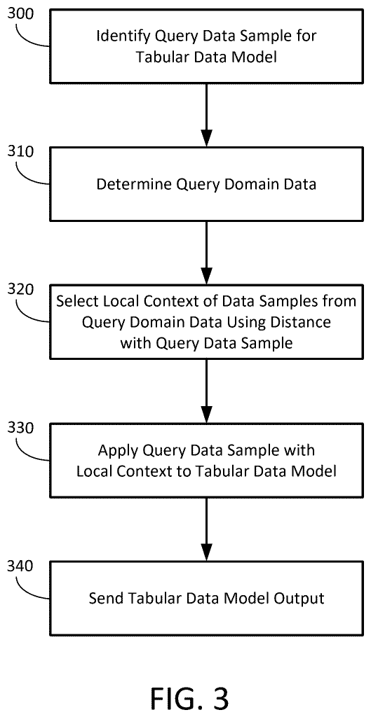

FIG. 3 is a flowchart of a method for evaluating queries for a tabular data model, according to one embodiment. This method may be performed, for example, by components of a tabular modeling system 100 as shown in FIG. 1, such as an inference module 110 in conjunction with a context selection module 120. Initially, a query may be identified 300 for application of a tabular data model to a data sample associated with the query. For example, a query may be received from an external system to obtain an output (e.g., a classification or regression) of the tabular data model. Initially, to determine a context for the data query, the query domain data is determined 310 to identify the set of data samples associated with a domain of the query. For example, a query request including a query data sample for tabular data of a medical data set may include identifying the relevant medical data set as the query domain data for the query.

In this example, a local context for the query is selected 320 from the data samples of the query domain data. The data samples associated with the query domain data may also be referred to as “domain data samples.” The query data sample is evaluated against domain data samples to determine the distance between the query data sample and various domain data samples as discussed above. A number of the domain data samples are selected as a local context for the query data sample. After determining the distance between the query data sample and the domain data samples, the domain data samples may be prioritized according to the distance for selection as the local context. In some embodiments, a number of nearest neighbor (NN) domain data samples are selected for the local context from the query domain data. The number of data samples selected for the local context may be fixed (e.g., 10, 30, or 50 data samples) or the number may vary (i.e., be dynamically selected). The number of context points may vary based on the domain, the distance of domain data samples to the query data sample, types of selected context points, and so forth.

In one embodiment, the number of selected domain data samples for the local context may be increased or decreased when the distance of the domain data samples is relatively higher or lower. For example, when the distance between the query data sample and an initial number of its nearest neighbors is relatively low or below a threshold (i.e., the nearest neighbors are relatively “close” to the query data sample), a smaller number of domain data samples are selected. Conversely, when the nearest domain data samples have a relatively higher distance to the query data sample (e.g., above a threshold), a larger number of domain data samples are selected.

In additional/further embodiments, the number of selected data samples may be based on a number of selected data samples for different aspects of the task. For example, for a classification task, a number of selected data samples may be obtained for each relevant classification. For example, in some embodiments, the size of the local context may be increased until a minimum number of domain data samples are included within each classification. For example, with a minimum number of five data samples, an initial number of context data samples may include sixteen data samples of a first classification and four data samples of a second classification. Additional domain data samples (i.e., based on distance to the query data sample) may then be selected until the local context includes the minimum number of each classification.

The query data sample is then applied 330 to the tabular data model using the local context. Finally, the tabular data model generates an output (in this case a classification) and the tabular data model classification is sent 340 as a result for the data query. The process may be repeated as new queries are received for processing, such that the related query data sample is identified 300, relevant query domain data is determined 310, and local context is selected 320 for subsequent query requests.

FIG. 4 shows an example data flow for generating a training batch for training the tabular data model, according to one embodiment. A brief overview of this data flow is shown with respect to FIG. 4 and additional details are discussed below. This example data flow may be processed by a training module 130 as discussed above when training the tabular data model. To obtain a tabular data model that may effectively process new data domains (e.g., that were not part of the training data), a training batch 440 may be determined from an overall set of model training data 400 by determining a training data input 445 from each training data set 410. As such, in this example, respective training data inputs 445A-C are obtained from training data sets 410A-C.

Each training data set 410A-C may represent a different type and/or domain of data. For example, training data set 410A may relate to biological data, training data set 410B may relate to financial data, and training data set 410C may relate to physics data. Accordingly, each training data set 410A-C may be represented as a table 420A-C having different fields (e.g., “columns” “field types” or “data types”) with different individual data samples (e.g., “rows”) indicate specific instances or data points within the respective training data set 410. Each table 420A-C may thus include a different number of columns having different field types, which may include text strings, classifications (e.g., selections among a limited set of unique values), integers, floating point values, dates, and so forth.

To obtain training data inputs that may be effective for many different types of potential query domain data, the training module selects a data field to be considered the target task to be predicted from the other data fields of the respective data samples. As such, the values of the target task are selected as labels for the selected data samples, while the remaining data fields may be used to generate respective input features for a set of data samples used for the training data input. In the example of FIG. 4, three selected data samples 430A-C are obtained from each training data set 410 and represented with a set of three input features. As shown in FIG. 4, the number of data fields may differ from the number of input features used to represent the data samples in the training data input. As such, the data values for the selected data samples may be normalized and otherwise modified to a standardized number of input features used by the tabular data model as discussed further below.

The selected data samples may be used as query data samples and context data samples in the training data input with respective labels used as an additional input for the context data samples or as a label to be learned by the tabular data model as discussed below. By generating training data batch having training data inputs across multiple training data sets that may have different data fields, determining target tasks without pre-existing labels, and processing the data fields without the target task field, the training batch may more closely mirror the variety of types of data that may be seen by the tabular data model when inferencing new data sets. In addition, by generating training batches including training data inputs that are standardized across training data sets and that include training data inputs from a plurality of training data sets, the training batch effectively includes multiple different data domains simultaneously, preventing individual training batches from too-heavily weighing model parameter updates towards aspects of an individual training data set.

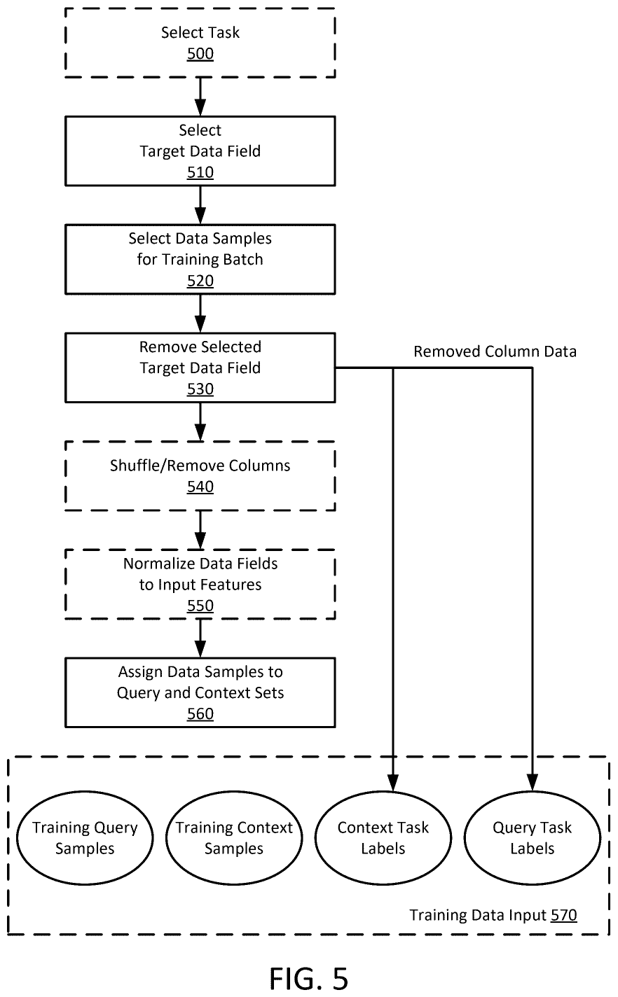

FIG. 5 shows an example process for determining a training data input for a training data set, according to one embodiment. This process may be performed, for example, by a training module 130 of a tabular modeling system 100 as shown in FIG. 1. This process may be performed for each of the training data sets as shown in FIG. 4 to generate respective training data inputs for a training batch.

Preliminarily, before generating the training data input as shown in FIG. 5, the training data set may be processed to clean and otherwise normalize the data for use with training the tabular data model. For example, in some situations, the training data set may be retrieved from an open-source data set or other data repository. The training data set may include data samples with missing data fields, data fields with varying value ranges, and so forth. The data values for each data field may be normalized, for example, to standardize the values for numerical values within a designated range. In addition, missing values may be replaced with a mean value or other standard value for the respective data field. In additional examples, the training data set may be further processed by identifying data samples or data fields that are related to one another and removing or otherwise correcting the data accordingly.

In certain embodiments, the tabular data model may be configured to predict outputs for one or more of a plurality of tasks, such as classification or regression. In these embodiments, each training data input 570 may be associated with a particular task to be trained for that training data input 570. The particular task may be selected 500 so that an appropriate data field may be selected 510 as the target data field for the task. From the plurality of data fields associated with the training data set, one data field may be selected 510 as the target data field to be associated with the task being predicted for the training data input 570.

In embodiments in which different tasks may be predicted by the tabular data model, the target data field may be selected 510 based on the selected task. Particularly, certain types of data fields may not be suitable for selection 510 as a target data field for certain types of tasks or may be further processed before use for a particular task. For example, regression tasks aim to predict a value as an output, such that the output value may predict a value that may represent a score or numerical evaluation of a quality of the data sample. Data fields that are also numerical values with a range may be eligible for selection 510 as the target data field, while data fields that do not readily provide a range (or conversion to a range), such as Boolean or text strings, may not be eligible to be selected 510 as the target data field for a regression task.

Particular data fields may be eligible for selection 510 for a particular task based on the values of the data field across multiple data samples in the data set. For example, a text string data field may be eligible as a classification task when the number of unique values of the data field across the training data set is within the number of classes that may be output by the classification task. In addition, numerical values may also be eligible for selection for a regression task when the numerical values have a range that may be binned and the bins may be used as class labels for the classification task.

The target data field may be selected 510 from the eligible data fields of the training data set. The target data field may be selected 510 with any suitable algorithm, and typically may include a process that is at least partially stochastic and includes one or more random elements. In one example, the target data field is randomly selected 510 from the eligible data fields.

Next a set of data samples may be selected 520 for the training batch. The set of data samples may be a subset of the data samples of the training data set and may subsequently form the context and query for the training data input 570. As such, the number of selected data samples may correspond to the number of context data samples and query data samples that may be used in the training data input 570. In some embodiments, the training data input 570 may simulate a “local” context, such that the training query samples and training context samples are from a similar region of the training data set. To do so, the data samples may be selected 520 based on a distance metric that may be measured in the training data set. Because the target data field is used as the label to be determined by the tabular data model, the distance metric may be evaluated without consideration of the target data field (i.e., the distance may be measured with the data fields of the training data set excluding the target data field). In one embodiment, the data samples for the training batch are selected 520 by determining a seed data sample and determining a neighborhood of data samples based on the distance metric around the seed data sample. The neighborhood of data samples may be determined, for example, as the nearest data samples to the seed data sample according to the distance metric.

Next, the values of the data samples may be retrieved for constructing the training data input 570 by removing 530 the target data field and setting the task labels (the context task labels and query task labels) for the data samples in the training data input 570. The remaining data fields (e.g., without the target data field) may then be used to characterize the data samples in the training data input 570. In various embodiments, the data fields (i.e., “columns” in the data table) may be further modified, for example, by shuffling 540 (re-ordering) the data fields or by removing one or more data fields (e.g., randomly) to simulate modified data sets in various ways.

Next, the data fields may be normalized 550 to a set of input features to characterize each data sample for input to the tabular data model. That is, the tabular data model may be configured to receive data samples characterized by a specified number of features having a particular data type (e.g., set of numerical features). For data samples having fewer data fields than the specified number, the data fields may be padded to reach the input features. For data samples having additional data fields than the specified number of input features, the data fields may be reduced to the number of input features, for example by dimensionality reduction (e.g., principle component analysis) or by removing additional data fields.

Finally, the selected data samples may be assigned 560 as training query samples and training context examples in the training data input 570 with corresponding task labels based on the removed target data field. The training data input 570 may then be included in a training data batch including additional training data inputs obtained from different training data sets.

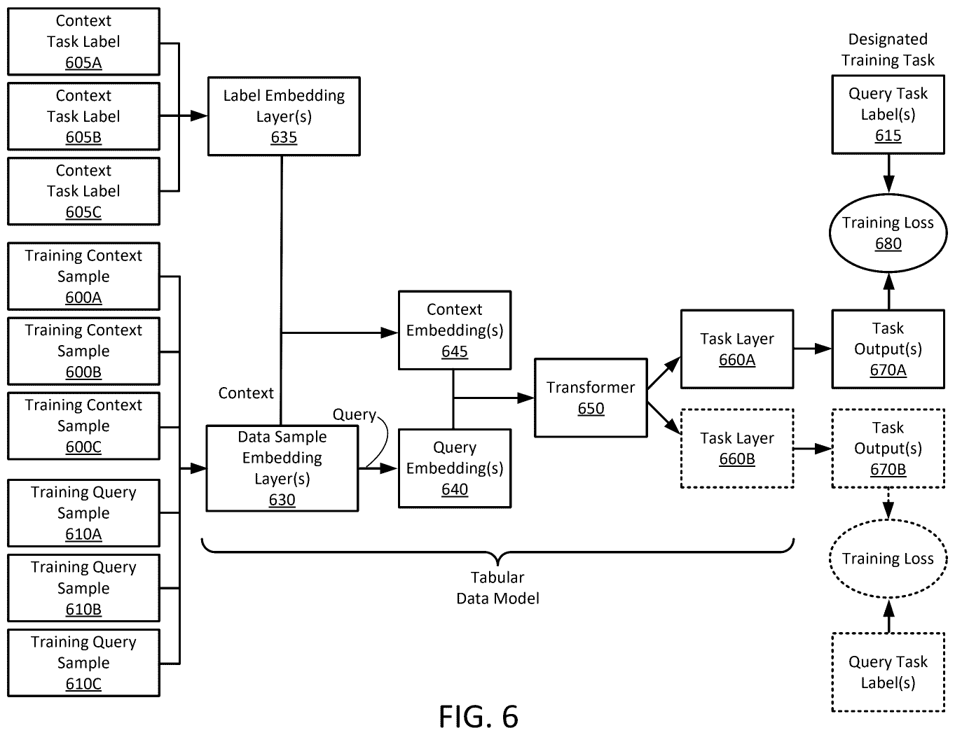

FIG. 6 illustrates an example data flow for training a tabular data model, according to one embodiment. FIG. 6 shows an example of a training data input (e.g., as shown in FIGS. 4 and 5) that includes a set of training context samples 600A-C and associated context task labels 605A-C along with training query samples 610A-C and associated query task labels 615. FIG. 6 shows one example architecture of a tabular data model that may include various trainable parameters in various processing layers, including embedding layers, transformer layers, and task layers.

In this example architecture, the data sample input features for the respective training context samples 600A-C and training query samples 610A-C are processed by a data sample embedding layer 630 to obtain embeddings representing each data sample. Particularly, the training query samples 610A-C are processed by the data sample embedding layer 630 to generate respective query embeddings 640. In addition to the output of the data sample embedding layer 630, context embeddings 645 are generated with an embedding output of a label embedding layer 635 applied to the context task labels 605A-C. As such, for each training context sample 600, a respective context embedding 645 combines the output of the data sample embedding layer 630 for the training context sample 600 and the output of the label embedding layer 635 applied to the respective context task label 605. In this embodiment, the context embedding 645 thus represents the input features of the context data sample along with its label. The data sample embedding layer and label embedding layer for the context samples may be combined in various ways, such as a sum of the respective values of the elements of the embeddings.

The query embeddings 640 and context embeddings 645 may then be processed by a transformer 650 to generate outputs for one or more task layers 660. The transformer 650 may be an attention-based model that applies attention across the context embeddings to predict outputs for processing by the task layers 660. The transformer 650 may be configured to attend across the context embeddings 645 but not across the query embeddings 640, such that multiple queries may be processed independently of other input queries and with consideration of the context data samples. In the example architecture of FIG. 6, the transformer 650 provides a backbone processing architecture to be jointly used by multiple tasks. During training, a designated training task is used to apply a respective task layer 660 to evaluate the transformer 650 output and obtain a respective task output 670.

In this example, the tabular data model includes two task layers 660A-B, which may relate to different types of predictive tasks, such as regression and classification, that outputs respective task outputs 670A-B. The character of the task outputs 670 may vary depending on the particular task. For example, a regression task may output a single value as a prediction for the task, while a classification task may output a set of logits or other representation of likelihood for each candidate class. In this example, the designated training task for the training data input relates to the first task of task layer 660A, such that the task output 670A for the respective training query samples 610A-C is evaluated with respective query task labels 615 to obtain a training loss 680 that may be used to train parameters of the tabular data model, which may include parameters of the respective task layer 660A, transformer 650, and embedding layers.

The loss function and training of the parameters may be based on the particular type of task. Any suitable training loss may be used according to the particular type of task. For example, a training loss 680 for a regression task may be based on a mean-squared error with respect to the query task labels 615, while classification tasks may use a cross-entropy loss relative to the labeled query task. The training loss may then be backpropagated or otherwise used to modify parameters of the tabular data model in the training batch. The data flow of FIG. 6 may be performed for each training data input in the training batch, which may include a mixture of different types of tasks for the training batch, such that, for example, some training data inputs may modify task layer 660A, and other training data inputs may modify task layer 660B according to the particular designated training task of the training data inputs.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system for self-supervised learning for tabular data, comprising:
one or more processors configured to execute instructions; and
one or more computer-readable media containing instructions executable by the one or more processor for:
identifying a plurality of training data sets, each training data set containing a plurality of data fields and data samples having values in the plurality of data fields;
for each training data set of the plurality of data sets:
selecting a target data field from the plurality of data fields;
determining a training data input including a subset of data samples from the plurality of data samples and comprising one or more context data samples and one or more query data samples, each of the subset of data samples described as input features determined without the target data field and having a label based on the target data field; and
training a tabular data model with the training batch to learn the label for the one or more queries of each of the plurality of training data inputs.

2. The system of claim 1, wherein determining the training data input comprises normalizing the input features for each data sample to a standardized feature quantity.

3. The system of claim 1, wherein determining the training data input comprises shuffling the data field ordering or removing one or more data fields.

4. The system of claim 1, wherein the target data field is not pre-determined or labeled in the plurality of training data sets.

5. The system of claim 1, wherein the plurality of training data sets are non-simulated data sets.

6. The system of claim 1, wherein the target data field is selected with a stochastic process.

7. The system of claim 1, wherein determining the training data input comprises selecting the subset of data samples from a neighborhood in the training data set.

8. The system of claim 7, wherein the instructions are further executable by the processor for selecting the neighborhood based on a distance metric that excludes the target data field.

9. The system of claim 1, wherein the tabular data model configured to output values for a plurality of tasks includes a regression task and a classification task; and
the instructions are further executable for:
selecting a training task and generating training data input comprises converting values for the target data field to values compatible with the selected task.

10. The system of claim 9, wherein the task is selected before selecting the target data field; and wherein selecting the target data field is based on the selected task.

11. The system of claim 1, wherein the instructions are further executable by the processor for applying the tabular data model to an inference data input corresponding to a data set not included in the plurality of training data sets.

12. A method for self-supervised learning, comprising:
identifying a plurality of training data sets, each training data set containing a plurality of data fields and data samples having values in the plurality of data fields;
for each training data set of the plurality of data sets:
selecting a target data field from the plurality of data fields;
determining a training data input including a subset of data samples from the plurality of data samples and comprising one or more context data samples and one or more query data samples, each of the subset of data samples described as input features determined without the target data field and having a label based on the target data field; and
training a tabular data model with the training batch to learn the label for the one or more queries of each of the plurality of training data inputs.

13. The method of claim 12, wherein determining the training data input comprises normalizing the input features for each data sample to a standardized feature quantity.

14. The method of claim 12, wherein determining the training data input comprises shuffling the data field ordering or removing one or more data fields.

15. The method of claim 12, wherein the target data field is not pre-determined or labeled in the plurality of training data sets.

16. The method of claim 12, wherein the plurality of training data sets are non-simulated data sets.

17. The method of claim 12, wherein the target data field is selected with a stochastic process.

18. The method of claim 12, wherein determining the training data input comprises selecting the subset of data samples from a neighborhood in the training data set.

19. The method of claim 18, further comprising selecting the neighborhood based on a distance metric that excludes the target data field.

20. A non-transitory computer-readable medium for self-supervised learning for tabular data, the non-transitory computer-readable medium comprising instructions executable by a processor for:
identifying a plurality of training data sets, each training data set containing a plurality of data fields and data samples having values in the plurality of data fields;
for each training data set of the plurality of data sets:
selecting a target data field from the plurality of data fields;
determining a training data input including a subset of data samples from the plurality of data samples and comprising one or more context data samples and one or more query data samples, each of the subset of data samples described as input features determined without the target data field and having a label based on the target data field; and
training a tabular data model with the training batch to learn the label for the one or more queries of each of the plurality of training data inputs.
